(19) United States
(12) Patent Application Publication
(10) Pub. No.: US 2009/0134304 A1
(43) Pub. Date: May 28, 2009

(54) Fastening system

(75) Inventors: Klaus Rieder, Weissach-Flacht (DE); Andreas Kohler, Bad Liebenzell (DE); Marcus Muller, Pforzheim (DE)

Correspondence Address: LERNER GREENBERG STEMER LLP, P O BOX 2480, HOLLYWOOD, FL, 33022-2480, US

(73) Assignee: Dr. Ing. h.c. F. Porsche Aktiengesellschaft, Weissach (DE)

(21) Appl. No.: 12/276,536

(22) Filed: Nov. 24, 2008

(30) Foreign Application Priority Data
Nov. 24, 2007 (DE) 10 2007 056 671.0

(51) Int. Cl. B60R 1/00; F16B 23/00

(52) U.S. Cl. 248/475.1; 411/378; 296/1.11

(57) ABSTRACT

A system for fastening an exterior mirror to a vehicle door has a reinforcement which is disposed fixedly in the vehicle door. The reinforcement has an insertion channel which receives an exterior mirror foot and a clamping device which can be actuated by at least one screw. A passage opening which is aligned with the insertion channel and is intended for the exterior mirror foot is provided in a door outer skin, and the at least one screw of the clamping device is accessible via an upwardly open door channel of the vehicle door.

### CROSS-REFERENCE TO RELATED APPLICATION

This application claims the priority, under 35 U.S.C. §119, of German application DE 10 2007 056 671.0, filed Nov. 24, 2007; the prior application is herewith incorporated by reference in its entirety.

### BACKGROUND OF THE INVENTION

### Field of the Invention

The present invention relates to a system for fastening an exterior mirror to a vehicle door, with a reinforcement which is arranged fixedly in the vehicle door. The invention also relates to a motor vehicle equipped with a fastening system of this type.

During the assembly of motor vehicles, working steps which obstruct one another under some circumstances, in particular during final assembly processes because of a previously defined assembly sequence, occur. For example, during fitting of an exterior mirror to a motor vehicle door, it is necessary to screw the exterior mirror or a holder for an exterior mirror from an inner side of a motor vehicle door. However, this results in that an interior door molding is only fitted in a subsequent fitting step. However, since it is frequently useful for the interior door molding of the vehicle door to be fitted before the exterior mirror, the accessibility of the fastening device of the exterior mirror is no longer ensured, since they are concealed by the interior door molding.

This problem would be solved, for example, by fastening the exterior mirror with screws which pass through the interior door molding. However, this solution is not generally acceptable for design considerations. By contrast, fastening the exterior mirror by screws which are accessible from the outside makes it easier to steal the exterior mirror, since the latter can simply be removed from the outside. By contrast, fastening the exterior mirror from the outside by theft-proof measures, for example theft-proof screws, in turn makes maintenance or exchange of the exterior mirror in the event of damage more difficult.

German Utility Model DE 601 05 743 T2 discloses a system of the type in question for fastening an exterior mirror to a vehicle door, in which the exterior mirror is screwed from the outside to a molding located in the vehicle door. In this case, at least one of the two fastening screws is secured by a locking screw which is accessible only when the vehicle door is open, and therefore removal of the exterior mirror from the outside is impossible when the vehicle door is closed.

Published, non-prosecuted German patent application DE 35 08 226 A1 discloses a vehicle with an exterior mirror, the foot of which is accommodated foldably in a holding part. The holding part is screwed in this case to the door of the motor vehicle via screws which are accessible from the outside, with the foot of the exterior mirror having to be pivoted in order to free access to the fastening screws.

Finally, laid-open German patent applications DE 2241861 and DE 2117620 each disclose exterior rear view mirrors which are held on a motor vehicle and are held on the motor vehicle door via in each case by at least one fastening screw which is accessible exclusively from the inside. In order to exchange the exterior mirror or a base of the respective exterior mirror, the interior door molding therefore has to be removed.

### SUMMARY OF THE INVENTION

It is accordingly an object of the invention to provide a rear light for a fastening system that overcomes the above-mentioned disadvantages of the prior art devices of this general type. The present invention is concerned with the problem of providing an improved embodiment or at least a different embodiment for a system of the type in question for fastening an exterior mirror to a vehicle door, the system firstly permitting easy fitting and disassembly of the exterior mirror without removal of an interior door molding, but secondly preventing undesirable removal of the exterior mirror when the vehicle is closed.

With the foregoing and other objects in view there is provided, in accordance with the invention, a system for fastening an exterior mirror to a vehicle door. The system contains a reinforcement disposed fixedly in the vehicle door. The reinforcement has an insertion channel formed therein for receiving an exterior mirror foot of the exterior mirror. A door outer skin of the vehicle door has a passage opening formed therein being aligned with the insertion channel and intended for the exterior mirror foot. A clamping device is actuated by at least one screw. The at least one screw is accessible via an upwardly open door channel of the vehicle door.

The invention is based on the general concept of clamping an exterior mirror in a vehicle door via a clamping device. The clamping device is actuable by at least one screw which is accessible via a door channel of the vehicle door. In this case, a fixedly arranged reinforcement is provided within the vehicle door. The reinforcement has an insertion channel which receives an exterior mirror foot and has the clamping device which can be actuated by the at least one screw. In this case, a passage opening which is aligned with the insertion channel and is intended for the exterior mirror foot is provided in a door outer skin, i.e., for example, a body sheet. If the exterior mirror is inserted by the associated exterior mirror foot into the insertion shaft of the reinforcement, then the screw which actuates the clamping device can be rotated simply by insertion of a screwdriver through the door channel without, for example, a previously fitted interior door molding having to be removed again in a complicated manner for this purpose. The accessibility through the door channel of the screw which actuates the clamping device permits the exterior mirror to be fitted to the vehicle door when the vehicle door is otherwise completely finished, and therefore it is not absolutely necessary for the interior door molding to be fitted only in a subsequent production step. At the same time, the accessibility of the screw which actuates the clamping device exclusively through the door channel permits reliable theft protection, since the door channel, for example a window channel when the motor vehicle door is closed, in which the side windows are usually likewise closed, is blocked and therefore insertion of a screwdriver which releases the screw can be effectively prevented. With the solution according to the invention, it is therefore possible to configure the production process to be more flexible and at the same time to improve the theft protection. Furthermore, the fastening system according to the invention also significantly facilitates fitting and removal of subsequent maintenance or repair of the exterior mirror. By the exterior mirror foot being pushed axially into the clamping device, tolerances between outer skin and reinforcement can be compensated for in a simple manner, and a visually satisfactory bearing of the exterior mirror foot against the outer skin is always ensured.

The clamping device expediently has two opposite dome-shaped clamping jaws which engage in clamping jaw receptacles which are formed in a complementary manner with respect thereto and are arranged on the reinforcement side. Clamping jaws of such a rounded configuration and the associated clamping jaw receptacles permit tolerances to be compensated for and at the same time secure the exterior mirror foot in an undercut-like manner in the insertion channel of the reinforcement. In particular the possibility of being able to compensate for certain angular tolerances, which occur, for example, because of the manufacturing process, by use of the clamping jaws which are configured in a dome-like manner affords a great advantage in comparison to fastening systems from the prior art, in which such a compensation of tolerances is impossible or possible only with very great difficulty.

According to an advantageous development of the solution according to the invention, the exterior mirror foot has, at its end which is in front in the insertion direction, an electric plug which, by the exterior mirror foot being inserted into the insertion channel of the reinforcement, can be connected to an electric coupling on the insertion channel side. In this case, the electric plug bunches together electric supply lines of the exterior mirror, the lines supplying, for example, an exterior mirror heating system or servomotors with electric energy. By the arrangement according to the invention of the plug at that end of the exterior mirror foot which is in front, seen in the insertion direction, and the provision at the same time of an electric coupling, which can be coupled therewith, in the insertion channel of the reinforcement, the great advantage is afforded that the electric coupling of the exterior mirror to the motor vehicle electric system no longer has to be produced separately, but rather is produced automatically if the exterior mirror is inserted by its insertion foot into the insertion channel. When it reaches its fitted position, a reliable electric connection to the motor vehicle electric system is provided.

It goes without saying that the features mentioned above and those which have yet to be explained below can be used not only in the respectively stated combination but also in different combinations or on their own without departing from the scope of the present invention.

Preferred exemplary embodiments of the invention are illustrated in the drawings and are explained in more detail in the description below, with the same reference numbers referring to identical or similar or functionally identical components.

Other features which are considered as characteristic for the invention are set forth in the appended claims.

Although the invention is illustrated and described herein as embodied in a fastening system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, sectional view through a vehicle door in a region of a fastening system according to the invention;

FIG. 2 is a diagrammatic, sectional view as in FIG. 1, but for a different variant of the fastening system.

### DETAILED DESCRIPTION OF THE INVENTION

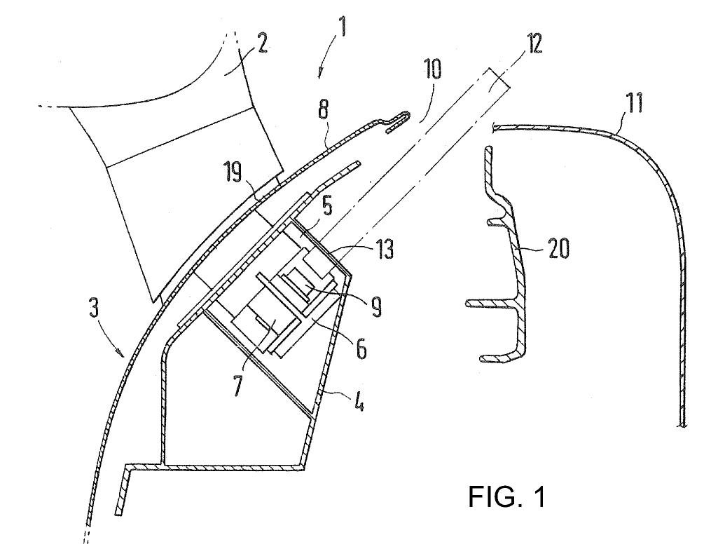

Referring now to the figures of the drawing in detail and first, particularly, to FIG. 1 thereof, there is shown a system 1 according to the invention for fastening an exterior mirror 2 to a vehicle door 3 that has a reinforcement 4 which is disposed fixedly in the vehicle door 3. The reinforcement 4 which is located within the vehicle door 3 has an insertion channel 5 in which—when the exterior mirror 2 is fitted—an exterior mirror foot 6 is inserted. In this case, the exterior mirror foot 6 and therefore the exterior mirror 2 are held via a clamping device 7 which clamps the exterior mirror foot 6 in relation to the reinforcement 4 and fixes it therein. In order to insert the exterior mirror foot 6 into the insertion shaft 5, an outer skin 8 of the vehicle door 3 has a corresponding passage opening which is disposed in such a manner that it is aligned with the insertion channel 5. The clamping device 7 is actuated by at least one screw 9, upon the rotation of which a clamping effect acting on the exterior mirror foot 6 is reinforced or reduced.

According to the invention, the at least one screw 9 of the clamping device 7 is now accessible via an upwardly open door channel 10 of the vehicle door 3. In contrast to the prior art, this affords the great advantage that the vehicle door 3 can already be substantially completely premanufactured before the exterior mirror 2 is fitted, since access to an interior of the vehicle door 3 is possible via the door channel 10. In particular, no further component 11, for example an interior door molding of the vehicle door 3, has to be removed in order to actuate the screw 9.

In order to fit the exterior mirror 2 in or to the vehicle door 3 according to FIG. 1, the exterior mirror 2 is therefore inserted by its exterior mirror foot 6 through the passage opening of the outer skin 8 into the insertion shaft 5. According to the embodiment of FIG. 1, the clamping device 7 is configured in the manner of a clip and surrounds the exterior mirror foot 6, which is of a substantially hollow-cylindrical configuration, on its peripheral side. After electric wiring, for example for the electric power supply of servomotors and/or heating elements arranged in the exterior mirror 2 is connected, a tool 12 is guided through the door channel 10 and is brought into operative connection with the screw 9, with tightening of the screw 9 bringing about a clamping effect on the exterior mirror foot 6. In this case, the clamping device 7 is connected fixedly to the reinforcement 4. After the screw 9 is tightened, the exterior mirror 2 is connected fixedly to the vehicle door 3. The tool 12 can be removed again from the door channel 10 after the screw has been tightened. Of course, the reinforcement 4 in this case has a corresponding reach-through opening 13 through which the tool 12 can be guided and can be subsequently brought into operative connection with the screw 9.

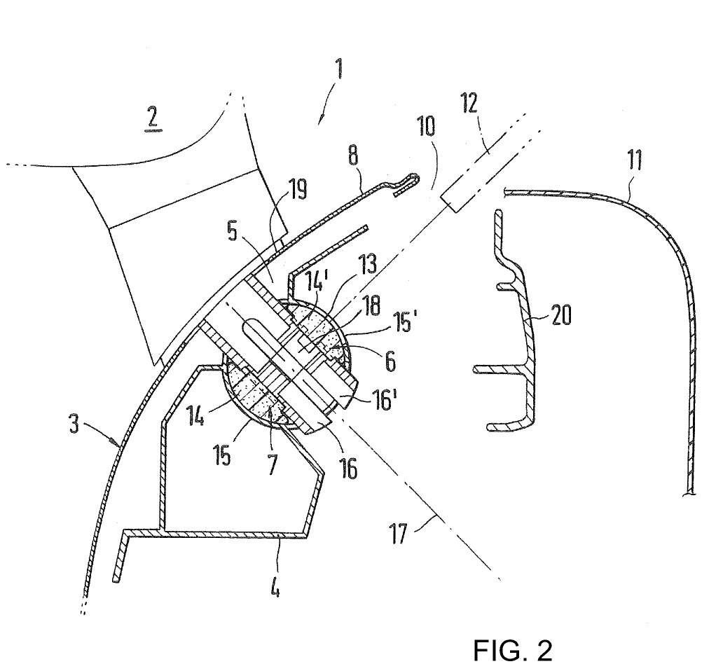

In general, it is conceivable here for the door channel 10, which is upwardly open according to FIGS. 1 and 2, to be configured as a window channel of a non-illustrated side window, and therefore a side window is usually guided in the door channel 10. In general, the system 1 according to the invention for fastening the exterior mirror 2 to the vehicle door 3 affords the great advantage of it not being necessary to adhere to a strict assembly sequence during the process of assembling the vehicle door 3, since even further components 11, such as, for example, an interior door molding, can already be disposed on the vehicle door 3 before the exterior mirror 2 is fitted. If, furthermore, the door channel 10 is configured as a window channel for a side window, then the system 1 according to the invention at the same time constitutes effective theft protection, since removal of the exterior mirror 2 is possible only when the door channel 10 is accessible, but the latter is usually sealed by the side window when the motor vehicle is closed, thus making access to the screw 9 difficult. At the same time, easy exchange of the exterior mirror 2 is possible during a subsequent maintenance/repair situation by the tool 12 simply being guided through the door channel 10 and the reach-through opening 13 to the reinforcement 4 in order to release the screw 9 of the clamping device 7. In this case, disassembly of an interior door molding 11 is not required either. The reference number 20 refers to the inside of a channel reinforcement.

In the second variant according to FIG. 2, the clamping device 7 has two opposite, dome-shaped clamping jaws 14 and 14′ which engage in clamping jaw receptacles 15 and 15′ which are formed in a complementary manner with respect thereto and are disposed on the reinforcement side. In this variant, the exterior mirror foot 6 has at least two expandable sections 16 and 16′ and an expanding screw 18 which runs transversely with respect to an axis 17 of the exterior mirror foot 6 and, upon tightening, causes radial expansion of the at least two expandable sections 16 and 16′ and therefore an undercut-like bracing of the two clamping jaws 14 and 14′ in the associated clamping jaw receptacles 15 and 15′. The expanding screw 18 here can be actuated by a tool 12 through the door channel 10 in an analogous manner to the variant according to FIG. 1. In this case, the expanding screw 18 is preferably constructed as a threaded pin (grub screw).

The exterior mirror 2 according to FIG. 2 is fitted as now described.

First, the two clamping jaws 14 and 14′ are placed into the insertion channel 5 using a non-illustrated fitting aid and are held in the associated clamping jaw receptacles 15 and 15′. Subsequently, the exterior mirror foot 6 of the exterior mirror 2 is pushed into the insertion channel 5, to be precise substantially perpendicularly to the door outer skin 8, with the exterior mirror 2 being pushed in until it bears with a bearing section 19 against the door outer skin 8. In a manner comparable to the variant illustrated in FIG. 1, the exterior mirror foot 6 and the clamping device 7, in particular the clamping jaws 14 and 14′, are fixed against rotation about an axis 17 according to the variant illustrated in FIG. 2. After the exterior mirror foot 6 has been fully inserted into the insertion channel 5, i.e. after it has reached its fitted position, any electric and/or mechanical connections present are made and the expanding screw 18 is subsequently tightened by the tool 12, as a result of which the two expandable sections 16 and 16′ of the exterior mirror foot 6 are spread against the clamping jaws 14 and 14′. Before the expanding screw 18 if fully tightened, compensation of at least small angular and/or positional tolerances is possible by the dome-like configuration of the two clamping jaws 14 and 14′, as a result of which tolerances in particular occurring only during the manufacturing process can more easily be compensated for.

In general, the electric and/or mechanical connecting elements are guided here through the exterior mirror foot 6 which is of a hollow configuration on the inside, with, according to a variant which is particularly preferred but is not shown, the exterior mirror foot 6 having, at its end which is in front in the insertion direction, an electric plug which, by the exterior mirror foot 6 being inserted into the insertion channel 5, can be coupled to an electric coupling disposed there. This avoids a separate fitting outlay for connection to the motor vehicle electric system, since the electric connection is accomplished simply by the exterior mirror foot 6 being pushed into the insertion channel 5. This helps in particular to reduce manufacturing and fitting costs.

It can likewise be provided that the clamping jaws 14 and 14′ are formed from an elastic material, in particular a vibration-reducing material, for example plastic or rubber, and, as a result, at least minimize transmission of vibrations from or into the exterior mirror 2. Such a vibration-reducing material can also be arranged on the bearing section 19, i.e. between the exterior mirror 2 and the door outer skin 8.

1. A system for fastening an exterior mirror to a vehicle door, the system, comprising:
a reinforcement disposed fixedly in the vehicle door, said reinforcement having an insertion channel formed therein for receiving an exterior mirror foot of the exterior mirror, a door outer skin of the vehicle door having a passage opening formed therein being aligned with said insertion channel and intended for the exterior mirror foot;
at least one screw; and
a clamping device being actuated by said at least one screw, and said at least one screw being accessible via an upwardly open door channel of the vehicle door.

2. The system according to claim 1, wherein said reinforcement has, in a region of said screw which actuates said clamping device, a correspondingly disposed reach-through opening formed therein such that a screwdriver guided through the door channel and said reach-through opening can be connected to said screw.

3. The system according to claim 1, wherein the exterior mirror foot is of a tubular design and said clamping device is a clip such that, when said clamping device is tightened, the exterior mirror foot is clamped in said clamping device.

4. The system according to claim 1, wherein:
said reinforcement has clamping jaw receptacles; and
said clamping device has two opposite, dome-shaped clamping jaws which engage in said clamping jaw receptacles configured in a complementary manner with respect to said opposite, dome-shaped clamping jaws.

5. The system according to claim 4, wherein the exterior mirror foot has at least two expandable sections and said at least one screw being an expanding screw which runs transversely with respect to an axis of the exterior mirror foot and, upon tightening, causes an expansion of said at least two expandable sections and therefore an undercut-like bracing of said two clamping jaws in said clamping jaw receptacles.

6. The system according to claim 5, wherein said expanding screw is a threaded pin namely a grub screw.

7. The system according to claim 1,
further comprising an electric coupling; and
wherein at least one of a mechanism which actuates the exterior mirror and electric supply lines are guided through the exterior mirror foot being a hollow exterior mirror foot, the exterior mirror foot having, at an end which is in front in a insertion direction, an electric plug which, by insertion of the exterior mirror foot into said insertion channel, can be connected to said electric coupling on an insertion channel side.

8. The system according to claim 1, wherein the upwardly open door channel is a window channel of a side window.

9. The system according to claim 4, wherein said clamping jaws are formed from an elastic material including from a vibration-reducing material.

10. A motor vehicle, comprising:
a vehicle door having a door outer skin and an upwardly open door channel formed therein;
an exterior mirror having an exterior mirror foot; and
a system for fastening said exterior mirror to said vehicle door, said system containing:
a reinforcement disposed fixedly in said vehicle door, said reinforcement having an insertion channel formed therein for receiving said exterior mirror foot, said door outer skin having a passage opening formed therein aligned with said insertion channel and intended for said exterior mirror foot;
at least one screw; and
a clamping device being actuated by said at least one screw, said at least one screw being accessible via said upwardly open door channel of said vehicle door.

11. The system according to claim 10, wherein said reinforcement has, in a region of said screw which actuates said clamping device, a correspondingly disposed reach-through opening formed therein such that a screwdriver guided through said door channel and said reach-through opening can be connected to said screw.

12. The system according to claim 10, wherein said exterior mirror foot is of a tubular design and said clamping device is a clip such that, when said clamping device is tightened, said exterior mirror foot is clamped in said clamping device.

13. The system according to claim 10, wherein:
said reinforcement has clamping jaw receptacles; and
said clamping device has two opposite, dome-shaped clamping jaws which engage in said clamping jaw receptacles configured in a complementary manner with respect to said opposite, dome-shaped clamping jaws.

14. The system according to claim 13, wherein said exterior mirror foot has at least two expandable sections and said at least one screw being expanding screw which runs transversely with respect to an axis of said exterior mirror foot and, upon tightening, causes an expansion of said at least two expandable sections and therefore an undercut-like bracing of said two clamping jaws in said clamping jaw receptacles.

15. The system according to claim 14, wherein said expanding screw is a threaded pin namely a grub screw.

16. The system according to claim 10, further comprising:
an electrical coupling; and
a mechanism and related supply lines for actuating said exterior mirror are guided through said exterior mirror foot being a hollow exterior mirror foot, said exterior mirror foot having, at an end which is in front in a insertion direction, an electric plug which, by insertion of said exterior mirror foot into said insertion channel, can be connected to said electric coupling on an insertion channel side.

17. The system according to claim 10, wherein said upwardly open door channel is a window channel of a side window.

18. The system according to claim 13, wherein said clamping jaws are formed from an elastic material including from a vibration-reducing material.
